(19) United States
(12) Patent Application Publication
(10) Pub. No.: US 2011/0180743 A1
(43) Pub. Date: Jul. 28, 2011

(54) EXSTINGUISHING AGENTS COMPRISING BLENDS OF FLUOROIODOCARBONS ADDED WITH DETOXIFYING COMPOUNDS

(75) Inventor: Gianluca Indovino, Formello-Roma (IT)

(73) Assignee: EXPLOSAFE INTERNATIONAL B.V., JB Amsterdam, NE (US)

(21) Appl. No.: 12/737,285

(22) PCT Filed: Jul. 1, 2009
(86) PCT No.: PCT/IT2009/000289

§ 371 Date: Apr. 6, 2011

(30) Foreign Application Priority Data
Jul. 1, 2008 (IT) RM2008A000358

(51) Int. Cl. A62D 1/00

(52) U.S. Cl. 252/2

(57) ABSTRACT

The present invention concerns an agent for extinguishing fire comprising fluoroiodocarbons added with detoxifying compounds, comprising one or more fluoroiodocarbons having the following general formula: CₓF_{y}l_{z} wherein x ranges between 1 and 3, y ranges between 1 and 7 and z ranges between 1 and 7 and a detoxifying agent chosen amongst terpenes, fat acids and vitamins.

The present invention concerns extinguishing agents comprising blends of fluoroiodocarbon added with detoxifying compounds.

The invention refers to the field of chemical compositions for extinguishing fires. In a more particular way, the invention refers to extinguishing compositions the use of which can be considered safe for human beings as well as for the environment. In particular, compositions according to this invention have a little effect or no effect in the process of the ozone layer depletion and give a little contribution or no contribution to the process of global warming known as “green-house effect”; but, at the same time, they are extremely performant in extinguishing fires.

A fire is the result of the combustion, i.e. an extremely exothermal chemical reaction of a combustible substance together with oxygen, accompanied by development of heat and flames. In order to give start to such a reaction it is necessary that a certain temperature, called ignition temperature, is reached, beyond that temperature the combustion starts, subsequently developing autonomously.

Conditions that can lead to the extinguishment of a fire are essentially three: the exhaustion of the combustible substance, the exhaustion of oxygen or the lowering of the temperature below the ignition temperature.

A fire extinguishment operation therefore can consist in making possible that one or more of the preceding conditions occur.

The operations that are most efficient are the operation of choking, by which oxygen is separated from the combustible substance or its presence in the air is dramatically reduced, and the operation of cooling, consisting in running over the burning material with suitable substances in order to lower its temperature.

Generally, extinguishing plants and devices in commerce, make use of substances allowing to obtain one or both the described effects.

In particular, to extinguish fires in closed or circumscribed rooms, such as for example rooms of computers, rooms of libraries, oil pumping stations in oil ducts and similar, extinguishing agents comprising halogenated hydrocarbons are preferred. These agents for extinguishing fires comprising halogenated hydrocarbons are not only effective for such fires, but cause very little damages or no damages to the room or its content.

Traditionally, these extinguishing agents comprising halogenated hydrocarbons were chosen amongst compounds containing bromine, thus called brominated halogenides. Since the end of the 80s, however, the increasing awareness towards environmental issues and in particular for the depletion of the stratospheric ozone layer, put under discussion the role of chlorofluorocarbons (CFC) and also that of bromine containing halogenocarbons, and the research moved towards the development of alternative extinguishing agents. The features of such agents, beside that of not to negatively affect the process of ozone depletion, but also that known with the name “green-house effect”. This effect is due to the accumulation of gases constituting a screen against heat transfer and produce as a result an undesirable overheating of the surface of the Earth.

Amongst the proposed solutions, a particular interest regarded extinguishing agents comprising hydrofluorocarbons, i.e. only partially fluorine substituted carbons.

European patent N. 439579 discloses a method for extinguishing fire comprising the step of introducing on the flame an extinguishing concentration of one or more compounds chosen from the group consisting of CF₃CHFCF₃, CF₃CH₂CF₃ and CF₃CHFCHF₂, and maintaining the compound concentration until the fire is extinguished.

European patent N. 494987 relates to a process and a composition for extinguishing fire based on a gaseous composition comprising CHF₃.

European patent N. 557275 discloses extinguishing blends consisting of at least ethane partially substituted with fluorine chosen from the group of pentafluoroethane (CF₃CHF₂) also known as HFC-125 and tetrafluoroethanes (CHF₂—CHF₂ and CF₃—CH₂F), also known as HFC-134 and HFC-134a.

PCT application N. WO 94/20588 discloses an extinguishing agent comprising at least a fluoroiodocarbon, alone or in combination with additives chosen, amongst the others, amongst hydrofluorocarbons. In particular, amongst fluoroiodocarbons, the application also provides for: trifluoroiodomethane (CF₃I), 1,1,1,2,3,3,3-eptafluoro-2-iodopropane (CF₃CFICF₃), and 1,1,2,2,3,3,3-eptafluoro-1-iodopropane (CF₃CF₂CF₂I), while amongst hydrofluorocarbons it also provides for: pentafluoroethane (CF₃CHF₂) and 1,1,1,2,3,3,3-eptafluoropropane (CF₃CHFCF₃). In the disclosure, however, this document does not cite specific examples of blends based on these compounds, nor discloses preferred ranges of concentration.

At last, in the publication Wright Laboratory N. WL-TR-96-3067 with title “Fluoroiodide blends as streaming agents: selection criteria and cup-burner results”, by Robert E. Tapscott, et al., June 1995, trifluoroiodomethane (CF₃I) is identified as the more promising extinguishing fluoroiodocarbon and its extinguishing features are inspected in blends together with different hydrofluorocarbons, amongst which in particular 1,1,1,2,3,3,3-eptafluoropropane (CF₃CHFCF₃), also known as HFC-227ea, and pentafluoroethane (CHF₂CF₃), also known as HFC-125.

A problem due to the use of fluorocarbons is their toxicity per for men. In particular, hydrofluorocarbons having a high number of hydrogen atoms with respect to fluorine agents, can decompose due to the fire, producing hydrogen fluoride (or hydrofluoric acid), that, at relatively high concentration, can be toxic.

U.S. Pat. No. 4,826,610 discloses some compounds that, added to an extinguishing agent constituted by a blend of fluorochlorocarbons, remove its toxicity. In particular, the patent presents the essential oils as detoxifying agents, and more in particular: limonene, geraniol, cypress oil, ruscus oil, bauhinia monandra oil, arbor vitae, millefoglio oil, cassia oil, rectified birchen oil, pine oil, fir oil, BQ (trademark of Field & co.).

U.S. Pat. No. 4,954,271 discloses non toxic extinguishing agents comprising fluorochlorocarbons chosen amongst trichlorofluoromethane, dichlorodifluoromethane, 1,2-dichlorotetrafluoroethane, chlorodifluoromethane, 1,1-dichloro-2,2,2-trifluoroethane, 1-chloro-1,2,2,2-tetrafluoroethane, pentafluoroethane, 1,2-dichloro-2,2-difluoroethane, 1,2,2,2-tetrafluoroethane and a detoxifying agent chosen amongst the group of terpenes: citral, citronella, citronellol, limonene, dipentene, menthol, terpinene, terpinolene, silvestrene, sabinene, mentadiene, zingiberene, ocimene, mircene, α-pinene, β-pinene, essence of turpentine, canphor, fitolo, vitamin A, abietic acid, squalene, lanosterol, saponin, oleanolic acid, lycopene, β-carotene, lutein, α-terpineol, paracimene; and unsaturated oils: oleic acid, linoleic acid, linolenic acid, eleostearic acid, lincanic acid, ricinoleic acid, palmitoleic acid, petroselinic acid, vaccinic acid, erucic acid.

Patent application N. WO 95/26218 discloses a method for extinguishing fires by means of a hydrofluorocarbon and a detoxifying agent chosen amongst terpenes, unsaturated oils, sodium bicarbonate, potassium bicarbonate, monoammonium phosphate, alkali metal halogenides and urea.

At last, U.S. Pat. No. 6,402,975 discloses halogenated extinguishing agents comprising from 90% to 99.9% by weight of a hydrocarbon at least partially halogenated chosen from the group consisting of: trifluoromethane, pentafluoroethane, 1,1,1,2-tetrafluoroethane, eptafluoropropane, esafluoropropane and pentafluoropropane, together with from 0.1% to 10% by weight of a detoxifying agent chosen amongst ethylene, butene, isoprene, pentene, isopentene, trimethylethylene, tetramethylethylene, pentadiene, isobutylene, dimethylbutadiene, hexene, hexadiene, methylpentadiene, hexatriene and limonene.

In this context it is provided the solution according to the present invention, with the aim of providing extinguishing blends of fluoroiodocarbons added with selected detoxifying agents.

The aim of the present invention is therefore that of providing extinguishing agents comprising blends of fluoroiodocarbons overcoming the limits of the solutions according to the prior art and to obtain the technical results previously disclosed.

A further aim of the invention is that said agents can be obtained with substantially limited costs, as far as both production costs and management costs are concerned.

Not least aim of the invention is that of providing extinguishing agents safe and reliable.

It is therefore a specific object of the present invention an agent for extinguishing fire comprising fluoroiodocarbons added with detoxifying compounds comprising one or more fluoroiodocarbons having the following general formula: CₓF_{y}I_{z} wherein x ranges between 1 and 3, y ranges between 1 and 7 and z ranges between 1 and 7 and a detoxifying agent chosen amongst terpenes, fat acids and vitamins.

In particular, according to the present invention, said fluoroiodocarbon is C₃F₇I.

Alternatively, always according to the invention, said fluoroiodocarbon is CF₃I.

Further, always according to the invention, said detoxifying agent is present in an amount comprised between 1 and 5% by weight and preferably is chosen amongst d-limonene, dipentene, p-cumene, β-pinene, oleic acid, vitamin E and still more preferably is β-pinene.

The invention will be disclosed in the following for illustrative, non limitative purpose, with reference to the enclosed figures wherein:

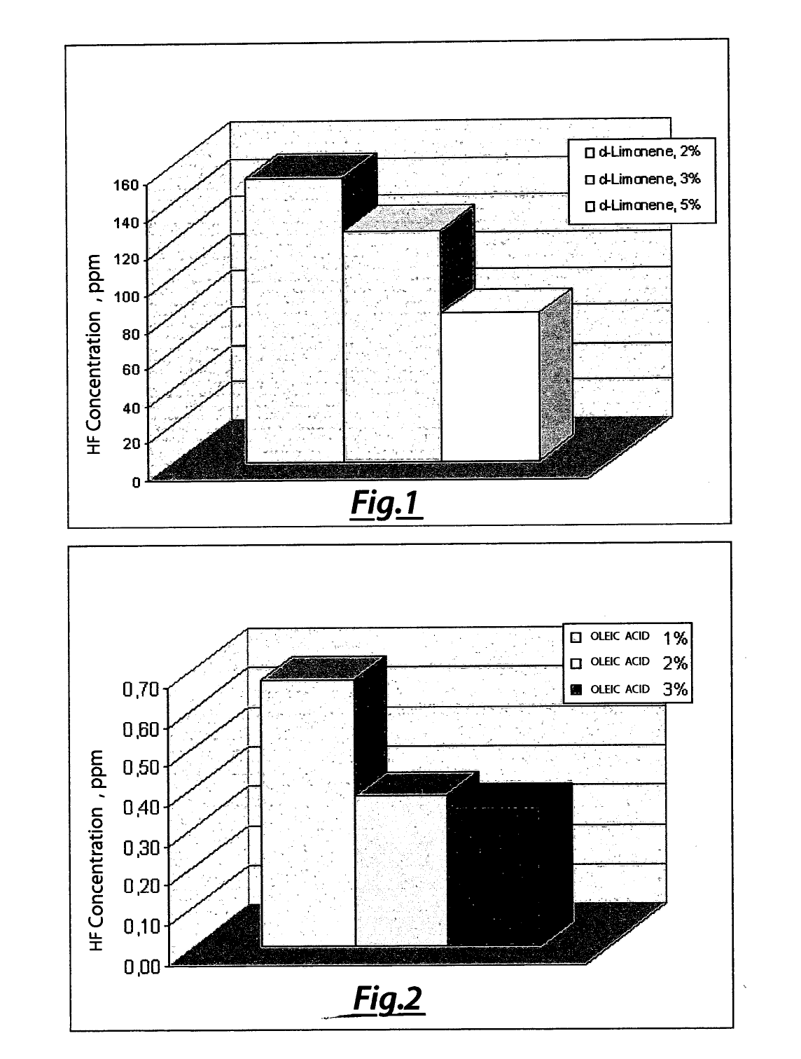

FIG. 1 shows a chart of the concentration of hydrofluoric acid formed during the extinguishment of a fire with a blend of iodoheptafluoropropane containing different amounts of limonene,

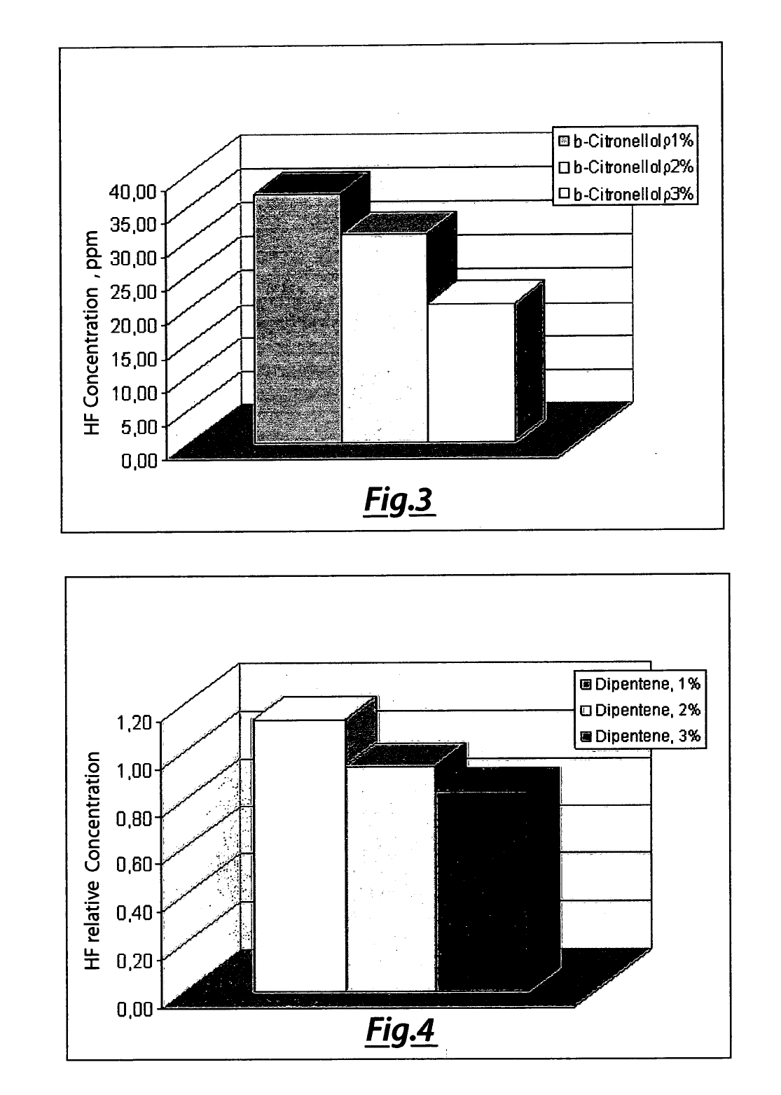

FIG. 2 shows a chart of the concentration of hydrofluoric acid formed during the extinguishment of a fire with a blend of iodoheptafluoropropane containing different amounts of oleic acid,

FIG. 3 shows a chart of the concentration of hydrofluoric acid formed during the extinguishment of a fire with a blend of iodoheptafluoropropane containing different amounts of β-citronellol,

FIG. 4 shows a chart of the concentration of hydrofluoric acid formed during the extinguishment of a fire with a blend of iodoheptafluoropropane containing different amounts of dipentene, and

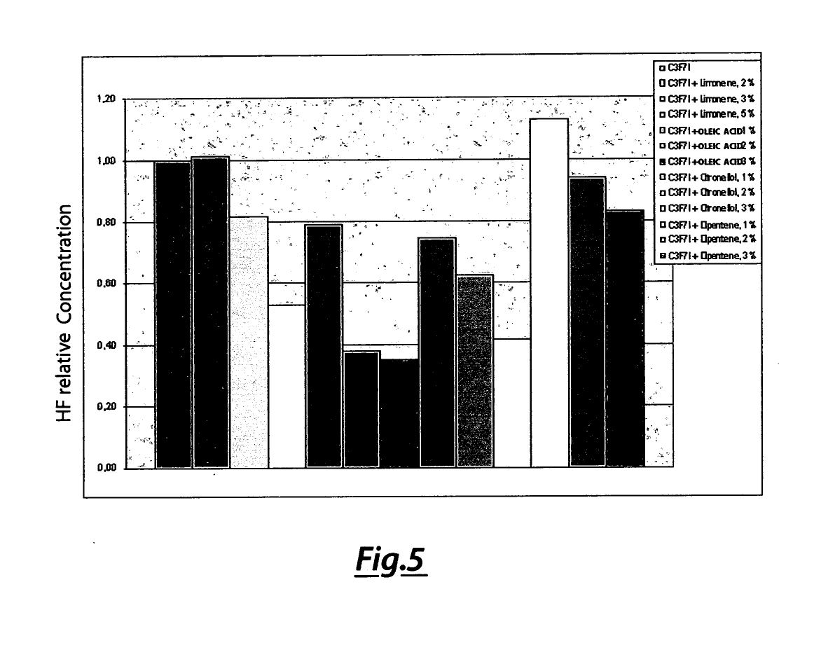

FIG. 5 shows a comparative chart of the concentration of hydrofluoric acid formed during the extinguishment of a fire with a blend of iodoheptafluoropropane containing different amounts of different detoxifying agents.

In order to identify the kind and optimal amount of detoxifying agent needed to minimize the decomposition of the by-products of the reactions of extinguishment of the flame, the determination of the amount of HF in the combustion smokes was performed.

Tests were performed using a closed container of 1 m³ having walls of polycarbonate with a thickness of 1.5 cm. The inlet to the closed container was realised through the from wall, also provided with a window for the observation of the interior of the container.

A plate with a diametre of 10 cm was positioned on a bottom surface, 15 cm above the floor in the middle of the container. The plate, containing 20 g of a liquid sample for each test, was heated by means of a methane flame obtained with a natural gas Bunsen burner.

Contact time between the sample and the flame was set at 60 s.

After the extinguishment of the flame, combustion smoke was collected for ISE (Ion Selected Electrode) testing by means of a gas flow passing through two glass bubblers having different volume for two hours. Both gas bubblers contained a trap solution comprising sodium hydroxide.

After the removal of the sample, the gas bulbs were let at rest for at least 24 hours in order to assure the complete neutralization of the acid gases obtained during the sampling procedure.

The resulting solution is then ready for testing in a specific fluorine electrode. Three subsequent measures were taken for the same sample and the average measure was calculated in order to determine the average concentration of HF.

At least three tests were performed for each additive under exam and the average value of concentration of HF in ppm was determined in order to obtain those reported of concentration of HF.

Iodoheptafluoropropane (C₃F₇I) was subjected to tests with a degree of purity of 100% and blended with the following compounds: d-limonene, purity 97%, CAS N. 5989-27-5; β-citronellol, purity 95%, CAS N. 106-22-9; dipentene, CAS N. 138-86-3; p-cumene; β-pinene; oleic acid, purity 90%, CAS N. 112-80-1; vitamin E (α-tocopherol), CAS N. 59-02-9.

The purpose of the test is the experimental evaluation of the scavenging effect of acids of the selected compounds with respect to the fluoroiodocarbons thermal decomposition products, in particular hydrogen fluoride.

d-limonene was tested at the concentration of 2%, 3% and 5%.

p-cumene and β-pinene were tested at a concentration of a 1%.

Other previously mentioned compounds were tested at concentrations of 1%, 2% and 3% with the exception of vitamin E that was tested only at a concentration of 2%.

Test results are shown in tables 1 to 7 and in FIGS. 1 to 4.

### EXAMPLE 1

### Blends of C₃F₇I with d-Limonene

The concentration of hydrofluoric acid resulting from a blend of C₃F₇I with d-limonene respectively at percentages of 2%, 3% and 5% was studied. Table 1 shows experimental values for each test performed and the calculated average values, and FIG. 1 shows the corresponding trend of the concentration of hydrofluoric acid.

TABLE 1
Concentration of HF (ppm)

d-limonene

| Test N. | C₃F₇I | 2% | 3% | 5% |
|---|---|---|---|---|
| 1 | 135.03 | 108.73 | 127.29 | 95.75 |
| 2 | 129.05 | 196.53 | 121.49 | 82.19 |
| 3 | 190.53 | | | 61.17 |
| Average | 151.54 | 152.63 | 124.39 | 79.70 |
| R_{eff} | 1.00 | 1.01 | 0.82 | 0.53 |

When the concentration of limonene is 2% it was not possible to observe any effect of removal of the acid, since the amount of produced HF was more or less the same with or without limonene (R_{eff}=1.01; this parametre represents an estimation of the efficiency of the added compound in the removal of hydrogen fluoride with respect to the amount obtained with pure iodoheptafluoroethane).

When the percent amount of limonene increases, the concentration of HF decreases, going down to half the initial value when the concentration of the additive reaches a value of 5% (R_{eff}=0.53).

### EXAMPLE 2

### Blends of C₃F₇I with Oleic Acid

The concentration of hydrofluoric acid resulting from a blend of C₃F₇I with oleic acid respectively at percentages of 1%, 2% and 3. Table 2 shows test values for each test performed and the calculated average values, and FIG. 2 shows the correspondent trend of the concentration of hydrofluoric acid in the fumes.

TABLE 2
Concentration of HF (ppm)

Oleic acid

| Test N. | C₃F₇I | 1% | 2% | 3% |
|---|---|---|---|---|
| 1 | 135.03 | | 66.15 | |
| 2 | 129.05 | | 43.81 | |
| 3 | 190.53 | | 63.38 | |
| 4 | 154.60 | | | |
| Average | 152.30 | | 57.78 | |
| R_{eff} | 1.00 | | 0.38 | |
| 1 | 74.75 | 21.76 | | 17.33 |
| 2 | 84.86 | 42.13 | | |
| 3 | 95.51 | 36.21 | | |
| 4 | 80.62 | | | |
| 5 | 39.99 | | | |
| 6 | 42.65 | | | |
| 7 | 32.99 | | | |
| 8 | 32.62 | | | |
| 9 | 32.63 | | | |
| 10 | 33.87 | | | |
| 11 | 54.77 | | | |
| 12 | 29.31 | | | |
| 13 | 27.27 | | | |
| 14 | 31.73 | | | |
| 1 | 74.55 | | | |
| Average | 49.53 | 33.37 | 57.78 | 17.33 |
| R_{eff} | 1.00 | 0.67 | 0.38 | 0.35 |

When the concentration of oleic acid is 1% it is possible to observe a reduction of the amount of HF of about 30% with respect to the average value obtained with pure iodoheptafluoroethane (R_{eff}=0.67).

When the percent amount of fat acid additive increases up to 2% a further improvement of the acid gas level reduction is obtained, the HF relative concentration (R_{eff}) resulting of 0.38.

A further increase of the percentage of oleic acid (3%) does not allow for a corresponding reduction of the hydrogen fluoride concentration, the parametre R_{eff}=0.53, being rather close to the value obtained with a 2% of additive.

### EXAMPLE 3

### Blends of C₃F₇I with β-Citronellol

The concentration of hydrofluoric acid resulting from a blend of C₃F₇I with β-citronellol respectively at percentages of 1%, 2% and 3% was examined. Table 3 shows test values for each test performed and the calculated average values, and FIG. 3 shows the correspondent trend of the concentration of hydrofluoric acid.

TABLE 3
Concentration of HF (ppm)

β-citronellol

| Test N. | C₃F₇I | 1% | 2% | 3% |
|---|---|---|---|---|
| 1 | 74.55 | 41.76 | 31.25 | 19.90 |
| 2 | 84.86 | 32.03 | 30.40 | 21.30 |
| 3 | 95.51 | | | |
| 4 | 80.62 | | | |
| 5 | 39.99 | | | |
| 6 | 42.65 | | | |
| 7 | 32.99 | | | |
| 8 | 32.62 | | | |
| 9 | 32.63 | | | |
| 10 | 33.87 | | | |
| 11 | 54.77 | | | |
| 12 | 29.31 | | | |
| 13 | 27.27 | | | |
| 14 | 31.73 | | | |
| 15 | | | | |
| Average | 49.53 | 36.90 | 30.83 | 20.60 |
| R_{eff} | 1.00 | 0.74 | 0.62 | 0.42 |

When the concentration of β-citronellol is 1% it is possible to observe a good effect of acid removal, since the amount of HF produced is is reduced of about 30% than without β-citronellol (R_{eff}=0.74; this parametre represents an estimation of the efficiency of the added compound in the removal of hydrogen fluoride with respect to the amount obtained with pure iodoheptafluoroethane).

When the percent amount of β-citronellol increases respectively to 2% and 3%, the concentration of HF decreases, going down to half the initial value when the concentration of the additive reaches a value of 3% (R_{eff}=0.42).

### EXAMPLE 4

### Blends of C₃F₇I with Dipentene

The concentration of hydrofluoric acid resulting from a blend of C₃F₇I with dipentene respectively at percentages of 1%, 2% and 3 was examined. Table 4 shows test values for each test performed and the calculated average values, and FIG. 4 shows the correspondent trend of the concentration of hydrofluoric acid in fumes.

TABLE 4
Concentration of HF (ppm)

Dipentene

| Test N. | C₃F₇I | 1% | 2% | 3% |
|---|---|---|---|---|
| 1 | 129.05 | | 123.15 | |
| 2 | 135.05 | | 123.77 | |
| Average | 132.04 | | 123.46 | |
| R_{eff} | 1.00 | | 0.94 | |
| 1 | 32.62 | 44.75 | | 28.05 |
| 2 | 32.63 | 33.43 | | 29.68 |
| 3 | 33.87 | | | |
| 4 | 54.77 | | | |
| 5 | 29.31 | | | |
| 6 | 27.27 | | | |
| 7 | 31.73 | | | |
| Average | 34.60 | 39.09 | | 28.87 |
| R_{eff} | 1.00 | 1.13 | 0.94 | 0.83 |

When the concentration of dipentene is 1% it is not possible to observe any acid removal effect, since the amount of HF produced was more or less the same with or without dipentene (R_{eff}=1.13; this parametre representing an estimation of the efficiency of the added compound in the removal of hydrogen fluoride with respect to the amount obtained with pure iodoheptafluoroethane).

When the percent amount of dipentene increases respectively up to 2% and 3%, the concentration of HF decreases, becoming about 20% smaller when the concentration of the additive reaches a value of 3% (R_{eff}=0.83).

### EXAMPLE 5

### Blends of C₃F₇I with Vitamina E

The concentration of hydrofluoric acid resulting from a blend of C₃F₇I with vitamin E in percentage of 2% was examined. Table 5 shows test values for each test performed and the calculated average values of the concentration of hydrofluoric acid.

TABLE 5
Concentration of HF (ppm)

Vitamin E

| Test N. | C₃F₇I | 1% | 2% | 3% |
|---|---|---|---|---|
| 1 | 135.03 | | 123.23 | |
| 2 | 129.05 | | | |
| 3 | 190.53 | | | |
| 4 | 154.60 | | 120.32 | |
| Average | 152.30 | | 121.78 | |
| R_{eff} | 1.00 | | 0.80 | |

At a percentage amount of vitamin E of 2% the concentration of HF decreases, going down of 20% (R_{eff}=0.80).

### EXAMPLE 6

### Blends of C₃F₇I with p-Cumene

The concentration of hydrofluoric acid resulting from a blend of C₃F₇I with p-cumene in percentage of 1% was examined. Table 6 shows test values for each test performed and the calculated average values of the concentration of hydrofluoric acid.

TABLE 6
Concentration of HF (ppm)

| | | p-cumene |
|---|---|---|
| Test N. | C₃F₇I | 1% |
| 1 | 84.90 | |
| 2 | 49.40 | |
| 3 | | 71.80 |
| 4 | | 57.28 |
| Average | 67.15 | 64.54 |
| R_{eff} | 1.00 | 0.96 |

At a percentage amount of p-cumene of 1% the concentration of HF decreases, however decreasing only of 4% (R_{eff}=0.96).

### EXAMPLE 7

### Blends of C₃F₇I with β-Pinene

The concentration of hydrofluoric acid resulting from a blend of C₃F₇I with β-pinene in percentage of 1% was examined. Table 7 shows test values for each test performed and the calculated average values of the concentration of hydrofluoric acid.

TABLE 7
Concentration of HF (ppm)

β-pinene

| Test N. | C₃F₇I | 1% | 2% | 3% |
|---|---|---|---|---|
| 1 | 84.90 | 46.81 | | |
| 2 | 49.40 | 46.84 | | |
| 3 | 73.56 | 60.43 | | |
| 4 | 66.55 | 49.89 | | |
| 5 | 66.79 | 51.29 | | |
| Average | 68.24 | 51.05 | | |
| R_{eff} | 1.00 | 0.75 | | |

At the percentage amount of β-pinene of 1% the concentration of HF decreases, decreasing of 25% (R_{eff}=0.75).

### EXAMPLE 8

### Comparation of the Test Values Obtained with Different Additives

On the base of test values shown in tables 1 to 7 and FIGS. 1 to 4, all to tested compounds appear to show an effect on the decomposition of hydrogen fluoride, oleic acid (a fat acid with very reactive double bounds), β-citronellol (a terpenoid) and β-pinene proving to be the most promising detoxifying agents.

Table 8 and FIG. 5 show all the test results together. In particular, the values in table 8 represent different values of the parametre R_{eff} as a consequence of a change in the nature and the concentration of the additives.

TABLE 8

| | Limonene | | | Oleic acid | | | β-Citronellol | | | Dipentene | | | β-pinene | p-cumene |
|---|---|---|---|---|---|---|---|---|---|---|---|---|---|---|
| C₃F₇I | 2% | 3% | 5% | 1% | 1% | 1% | 1% | 2% | 3% | 1% | 2% | 3% | 1% | 1% |
| 1.00 | 1.01 | 0.82 | 0.53 | 1.13 | 1.13 | 1.13 | 0.74 | 0.62 | 0.42 | 1.13 | 0.94 | 0.83 | 0.75 | 0.96 |

As it is possible to observe by comparing the values of the parametre R_{eff} as a consequence of a change in the nature and the concentration of the additives, 2% limonene, 1% p-cumene and 1% and 2% dipentene do not appear to have a significative effect on the reduction of the concentration di HF, since the relative concentration of hydrofluoric acid, determined with the method of the ion selective electrode, is rather similar to that obtained in experimental tests wherein pure C₃F₇I was used. In fact, the parametre R_{eff}, representing the efficiency of the tested compounds as acid scavengers, is 1.01 in case of d-limonene at the concentration of 2%, and 1.13 and 0.93 for dipentene respectively at concentrations of 1% and 2% (reference value being 1.00 and referring to C₃F₇I).

A rather good effect in the decreasing of the concentration of the thermal decomposition by-products can be obtained at a concentration of the two terpenes of 3%; when the concentration of d-limonene and dipentene is 3%, the relative concentration of hydrofluoric acid decreases of about 20% with respect to the reference value, in this case the parametre R_{eff} being about 0.8 both for d-limonene and for dipentene.

A more evident acid removal effect is obtained by using a higher concentration of terpene (see the results of d-limonene at 5%), with R_{eff}=0.53.

Particularly promising effect already at low concentrations were obtained using 1% β-pinene.

d-limonene and dipentene belong to the same chemical family. In fact, limonene is a hydrocarbon, classified as a cyclic terpene. It also has a chiral molecule, the most common form being the enantiomer called d-limonene, the racemate being known as dipentene.

Oleic acid and β-citronellol proved to be the most promising additives, since they showed a significative effect as acid scavengers.

Oleic acid is a monounsaturated omega-9 fat acid, having formula C₁₈H₃₄O₂ (i.e. CH₃(CH₂)₇CH═CH(CH₂)₇COOH); as with most organic liquids, a fire is possible at high temperature or as a consequence of the contact with an ignition source.

Oleic acid proved to have an important effect in lowering the concentration di HF already at the lower percentage between those studied, only 1%: as shown in table 6, the relative concentration of hydrofluoric acid is about 20% lower with respect to the reference value referred to pure C₃F₇I (R_{eff}=0.79).

The acid removal effect obtained by means of oleic acid appear to increase at the increasing of the amount of this additive in the extinguishing blend. In fact, for concentrations of 2% and 3%, it was observed a significative reduction of the level of acid gas, the estimated efficiency parameter being respectively of 0.38 and 0.35.

Citronellol is a natural acyclic monoterpenoid. Both the enantiomers are present in nature, the most common being (+)-β-citronellol.

As the oleic acid, β-citronellol showed a significative acid removal effect at the three different percentage under examination, i.e. 1%, 2% and 3%. The most effective concentration showed to be 3%.

Adding 3% β-citronellol to the extinguishing blend comprising iodofluorocarbon, it was determined a value of the parametre R_{eff} of 0.42, i.e. the concentration of HF decreases of about 60% with respect to the reference value of C₃H₇I.

The present invention was described for illustrative, non limitative purposes, according to its preferred embodiments, but it is intended that variations and/or modifications can be made by the skilled in the art without escaping the correspondent scope of protection, as defined in the enclosed claims.

1. Agent for extinguishing fire comprising fluoroiodocarbons added with detoxifying compounds, characterised in that it comprises one or more fluoroiodocarbons having the following general formula: CₓFyI₂ wherein x ranges between 1 and 3, y ranges between 1 and 7 and z ranges between 1 and 7 and a detoxifying agent chosen amongst terpenes, fat acids and vitamins.

2. Agent for extinguishing fire according to claim 1, characterised in that said fluoroiodocarbon is C₃F₇I.

3. Agent for extinguishing fire according to claim 1, characterised in that said fluoroiodocarbon is CF₃I.

4. Agent for extinguishing fire according to claim 1, characterised in that said detoxifying agent is present in concentration comprised between 1 and 5% by weight.

5. Agent for extinguishing fire according to claim 1, characterised in that said detoxifying agent is chosen amongst d-limonene, β-citronellol, dipentene, p-cumene, β-pinene, oleic acid, vitamin E.

6. Agent for extinguishing fire according to claim 5, characterised in that said detoxifying agent is β-pinene.
